(19) United States
(12) Patent Application Publication
(10) Pub. No.: US 2020/0400298 A1
(43) Pub. Date: Dec. 24, 2020

(54) CONNECTABLE LAMP DEVICE AND CONNECTABLE LAMP DEVICE ASSEMBLY

(71) Applicant: Xiamen PVTECH Co., Ltd., Xiamen (CN)

(72) Inventors: FUXING LU, Xiamen (CN); XIAOPING LAN, Xiamen (CN)

(21) Appl. No.: 16/590,366

(22) Filed: Oct. 1, 2019

(30) Foreign Application Priority Data
Jun. 18, 2019 (CN) 201910527611.4

(51) Int. Cl. F21V 23/06; F21V 15/015; F21S 8/00; F21V 21/088; F21V 17/10; F21K 9/272

(52) U.S. Cl. CPC F21V 23/06; F21V 15/015; F21K 9/272; F21V 21/088; F21V 17/105; F21S 8/00

(57) ABSTRACT

A connectable lamp device includes a lamp tube, a first cover body, and a second cover body. The lamp tube includes an upper housing and a lower housing connected to the upper housing. Two ends of the lamp tube include a first tube end and a second tube end, respectively. The outer portion of the first cover body includes a first connecting structure, and the inner portion of the first cover body covers the first tube end. The outer portion of the second cover body includes a second connecting structure, and the inner portion of the second cover body covers the second tube end. Accordingly, several lamp devices may be utilized to replace the lamp panel, and the lamp devices can be utilized in a convenient manner and are applicable in different circumstances.

### CROSS REFERENCE TO RELATED APPLICATION

This application claims priority of China Application No. 201910527611.4, filed on Jun. 18, 2019. The entirety of the above-mentioned patent application is incorporated by reference herein and made a part of this specification.

### BACKGROUND OF THE INVENTION

### 1. Field of the Invention

The present invention relates to a lamp device, in particular to a connectable lamp device and a connectable lamp device assembly.

### 2. Description of the Prior Art

Lighting apparatuses become essential parts in daily lives. Lighting apparatuses may be applicable to different fields, for example, may be household lights, commercial lights, industrial lights, and traffic lights.

In other words, lighting apparatuses are widely used, so that manufacturers develop different lighting apparatuses for different needs.

Typical lighting apparatuses like lamp panels are used in commercial buildings. However, it is understood that, the installation for the lamp panels is time-consuming. Moreover, the lamp panels cannot be installed to the buildings in a flexible manner, on the other hand, the circumstances for installing the lamp panels are required to meet some criteria. Therefore, it is an issue to design a lamp device which can be installed flexibly and conveniently so as to improve the drawbacks of the foregoing mentioned lamp panels.

### SUMMARY OF THE INVENTION

In view of these, in one embodiment, a connectable lamp device is provided. The connectable lamp device comprises a lamp tube, a first cover body, and a second cover body.

The lamp tube comprises an upper housing and a lower housing connected to the upper housing. Two ends of the lamp tube comprise a first tube end and a second tube end, respectively. The first cover body has a first outer portion and a first inner portion, the first outer portion of the first cover body comprises a first connecting structure, and the first inner portion of the first cover body covers the first tube end. The second cover body has a second outer portion and a second inner portion, the second outer portion of the second cover body comprises a second connecting structure, and the second inner portion of the second cover body covers the second tube end.

In one or some embodiments, the connectable lamp device further comprises at least one positioning member on an outer surface of the upper housing.

In one or some embodiments, the at least one positioning member comprises a clamp and a magnet body, the clamp clamps the upper housing, and the magnet body is on the clamp.

In one or some embodiments, a cross section of the upper housing is of a rectangular shape, and a cross section of the lower housing is of a U shape.

In one or some embodiments, the first connecting structure is a receptacle or a plug, and the second connecting structure is a plug or a receptacle, correspondingly.

A connectable lamp device assembly comprises two connectable lamp devices as mentioned above and a connecting wire. The two connectable lamp devices are arranged parallelly. The first cover body of one of the connectable lamp devices and the second cover body of the other connectable lamp device are at the same side. The connecting wire is connected to the two connectable lamp devices. The connecting wire comprises a wire body, a first connection portion, and a second connection portion. The first connection portion and the second connection portion are respectively at two ends of the wire body. The first connection portion is adapted to be mounted in the first connecting structure of one of the connectable lamp devices, and the second connection portion is adapted to be mounted in the second connecting structure of the other connectable lamp device.

In one or some embodiments, a connecting portion between the wire body and the first connection portion forms a right angle, and a connecting portion between the wire body and the second connection portion forms a right angle.

In one or some embodiments, the connectable lamp device assembly further comprises a power supply wire connected to the other connectable lamp device. The power supply wire comprises a wire portion and a third connection portion at one end of the wire portion. The third connection portion is adapted to be mounted in the first connecting structure of the other connectable lamp device.

In one or some embodiments, a connecting portion between the wire portion and the third connection portion forms a right angle.

In one or some embodiments, the connectable lamp device assembly further comprises a plurality of positioning members on the lamp tubes of the connectable lamp devices. Each of the positioning members comprises a clamp and a magnet body. The clamps clamp the upper housings of the connectable lamp devices, and the magnet bodies are on the clamps.

Based on the above, the connectable lamp device and the connectable lamp device assembly according to one or some embodiments of the present invention have following advantages. In one embodiment, several lamp devices may be utilized to replace the lamp panel, and the lamp devices can be utilized in a convenient manner and are applicable in different circumstances. In one embodiment, the positioning member is provided the magnet body, so that the assembling of the lamp devices can be performed without drilling. Moreover, in one embodiment, the angle of the connecting portion between the first connection portion and the wire body as well as the angle of the connecting portion between the second connection portion and the wire body are right angles, so that the connecting wire and the connectable lamp devices can be assembled conveniently with reduced assembling space; the configuration of the power supply wire also has similar advantages.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a partial exploded view of a connectable lamp device according to an exemplary embodiment of the present invention;

FIG. 2 illustrates a perspective view of a positioning member of the connectable lamp device of the exemplary embodiment;

FIG. 3 illustrates a perspective view of a connecting wire of the connectable lamp device of the exemplary embodiment;

FIG. 4 illustrates a perspective view of a power supply wire of the connectable lamp device of the exemplary embodiment;

FIG. 5 illustrates a perspective view of a connectable lamp device assembly according to an exemplary embodiment of the present invention; and

FIG. 6 illustrates a top view of the connectable lamp device assembly of the exemplary embodiment.

### DETAILED DESCRIPTION

The detailed features and the advantages of the present invention will become more obvious from the following description for any person having ordinary skills in the art to carry out the claimed invention. Further, based on the disclosure, the claims, and the accompanying drawings, any person having ordinary skills in the art can understand the purpose and the advantages of the present invention easily.

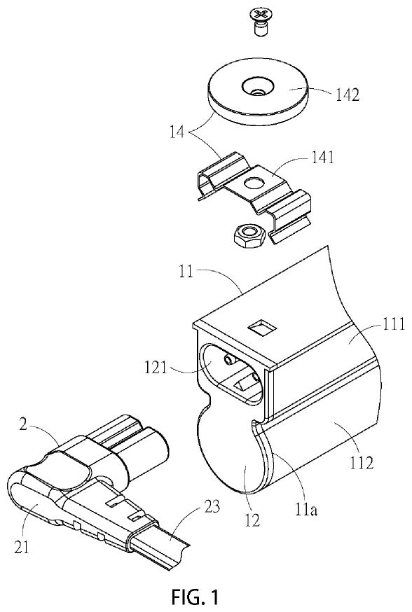

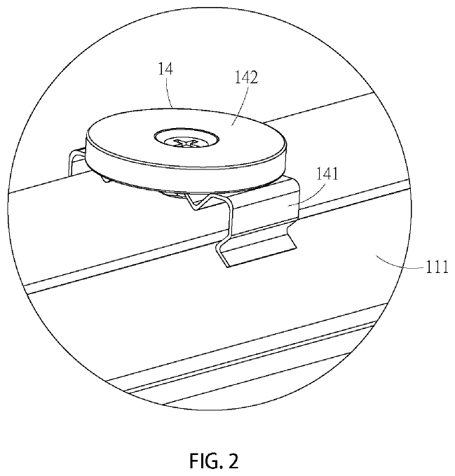

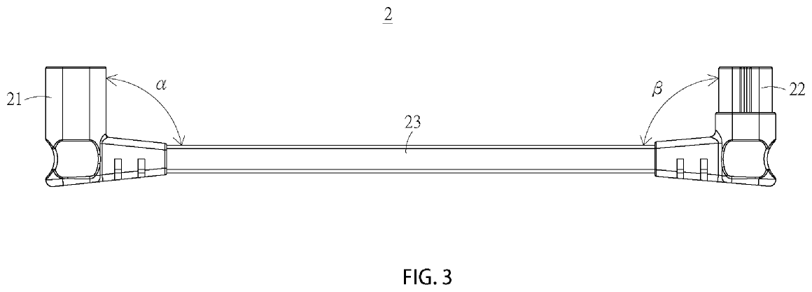

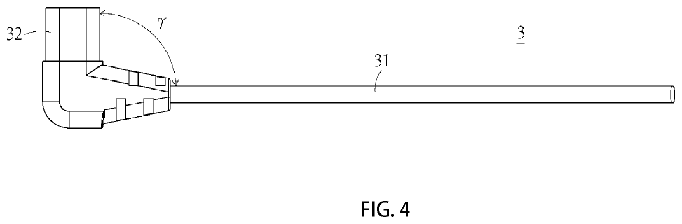

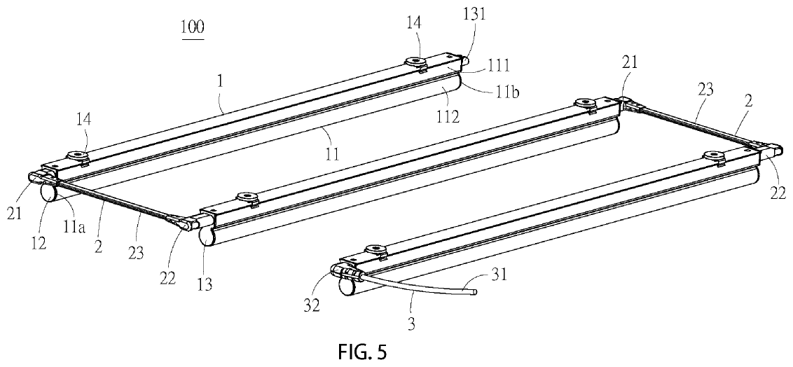

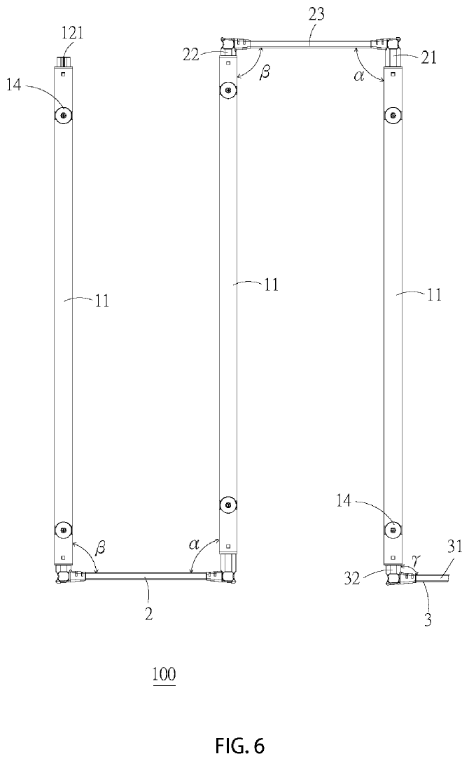

Please refer to FIGS. 1 to 6. FIG. 1 illustrates a partial exploded view of a connectable lamp device 1 according to an exemplary embodiment of the present invention. FIG. 2 illustrates a perspective view of a positioning member of the connectable lamp device 1 of the exemplary embodiment. FIG. 3 illustrates a perspective view of a connecting wire of the connectable lamp device 1 of the exemplary embodiment. FIG. 4 illustrates a perspective view of a power supply wire of the connectable lamp device 1 of the exemplary embodiment. FIG. 5 illustrates a perspective view of a connectable lamp device assembly 100 according to an exemplary embodiment of the present invention. FIG. 6 illustrates a top view of the connectable lamp device assembly 100 of the exemplary embodiment.

In this embodiment, the connectable lamp device 1 comprises a lamp tube 11, a first cover body 12, and a second cover body 13.

The lamp tube 11 comprises an upper housing 111 and a lower housing 112 connected to the upper housing 111. Two ends of the lamp tube 11 comprise a first tube end 11a and a second tube end 11b, respectively. That is, one of the two ends of the lamp tube 11 comprises the first tube end 11a, and the other end of the lamp tube 11 comprises the second tube end 11b. The outer portion of the first cover body 12 comprises a first connecting structure 121, and the inner portion of the first cover body 12 covers the first tube end 11a. The outer portion of the second cover body 13 comprises a second connecting structure 131, and the inner portion of the second cover body 13 covers the second tube end 11b.

Moreover, in one embodiment, the connectable lamp device 1 comprises at least one positioning member 14 on an outer surface of the upper housing 111.

As shown in FIG. 2, the positioning member 14 comprises a clamp 141 and a magnet body 142. The clamp 141 clamps the upper housing 111, and the magnet body 142 is on the clamp 141.

As shown in FIG. 1, the cross section of the upper housing 111 is of a rectangular shape, and the cross section of the lower housing 112 is of a U shape.

In some embodiments, the first connecting structure 121 is a receptacle or a plug and the second connecting structure 131 is a plug or a receptacle, correspondingly. In other words, when the first connecting structure 121 is a receptacle, the second connecting structure 131 is a plug for mating with the receptacle; conversely, when the first connecting structure 121 is a plug, the second connecting structure 131 is a receptacle for mating with the plug; embodiments are not limited thereto.

As shown in FIGS. 5 and 6, a connectable lamp device assembly 100 is also provided. The connectable lamp device assembly 100 comprises two connectable lamp devices 1 as mentioned above and a connecting wire 2. In this embodiment, the assembly has three lamp devices, and configuration of two lamp devices of the assembly is described as below.

The two connectable lamp devices 1 are arranged parallelly, and the first cover body 12 of one of the connectable lamp devices 1 (hereinafter, for the sake of convenience, the first connectable lamp device) and the second cover body 13 of the other connectable lamp device 1 (hereinafter, for the sake of convenience, the second connectable lamp device) are located at a same side. The connecting wire 2 is connected to the two connectable lamp devices 1. The connecting wire 2 comprises a wire body 23, a first connection portion 21, and a second connection portion 22. The first connection portion 21 and the second connection portion 22 are respectively at two ends of the wire body 23. The first connection portion 21 is adapted to be inserted to the first connecting structure 121 of the first connectable lamp device, and the second connection portion 22 is adapted to be mounted in the second connecting structure 131 of the second connectable lamp device.

Moreover, the angle α of the connecting portion between the wire body 23 and the first connection portion 21 forms a right angle, and the angle β of the connection portion between the wire body 23 and the second connection portion 22 forms a right angle.

Please refer to FIGS. 1, 5, and 6. The connectable lamp device assembly 100 further comprises a power supply wire 3 connected to the second connectable lamp device. The power supply wire 3 comprises wire portion 31 and a third connection portion 32 at one end of the wire portion 31. The third connection portion 32 is adapted to be mounted in the first connecting structure 121 of the second connectable lamp device.

In one embodiment, the angle γ of the connection portion between the wire portion 31 and the third connection portion 32 forms a right angle.

Based on the above, the connectable lamp device and the connectable lamp device assembly according to one or some embodiments of the present invention have following advantages. In one embodiment, several lamp devices may be utilized to replace the lamp panel, and the lamp devices can be utilized in a convenient manner and are applicable in different circumstances. In one embodiment, the positioning member is provided the magnet body, so that the assembling of the lamp devices can be performed without drilling. Moreover, in one embodiment, the angle of the connecting portion between the first connection portion and the wire body as well as the angle of the connecting portion between the second connection portion and the wire body are right angles, so that the connecting wire and the connectable lamp devices can be assembled conveniently with reduced assembling space; the configuration of the power supply wire also has similar advantages.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A connectable lamp device, comprising:
a lamp tube comprising an upper housing and a lower housing connected to the upper housing, wherein two ends of the lamp tube comprise a first tube end and a second tube end, respectively;
a first cover body having a first outer portion and a first inner portion, wherein the first outer portion of the first cover body comprises a first connecting structure, and the first inner portion of the first cover body covers the first tube end; and
a second cover body having a second outer portion and a second inner portion, wherein the second outer portion of the second cover body comprises a second connecting structure, and the inner portion of the second cover body covers the second tube end.

2. The connectable lamp device according to claim 1, further comprising at least one positioning member on an outer surface of the upper housing.

3. The connectable lamp device according to claim 2, wherein the at least one positioning member comprises a clamp and a magnet body, the clamp clamps the upper housing, and the magnet body is on the clamp.

4. The connectable lamp device according to claim 1, wherein a cross section of the upper housing is of a rectangular shape, and a cross section of the lower housing is of a U shape.

5. The connectable lamp device according to claim 1, wherein the first connecting structure is a receptacle or a plug and the second connecting structure is a plug or a receptacle, correspondingly.

6. A connectable lamp device assembly comprising:
two connectable lamp devices according to claim 1, wherein the two connectable lamp devices are arranged parallelly, and the first cover body of one of the connectable lamp devices and the second cover body of the other connectable lamp device are located at a same side; and
a connecting wire connected to the two connectable lamp devices, wherein the connecting wire comprises a wire body, a first connection portion, and a second connection portion, the first connection portion and the second connection portion are respectively at two ends of the wire body, the first connection portion is adapted to be mounted in the first connecting structure of one of the connectable lamp devices, and the second connection portion is adapted to be mounted in the second connecting structure of the other connectable lamp device.

7. The connectable lamp device assembly according to claim 6, wherein a connecting portion between the wire body and the first connection portion forms a right angle, and a connecting portion between the wire body and the second connection portion forms a right angle.

8. The connectable lamp device assembly according to claim 6, further comprising a power supply wire connected to the other connectable lamp device, wherein the power supply wire comprises a wire portion and a third connection portion at one end of the wire portion, the third connection portion is adapted to be mounted in the first connecting structure of the other connectable lamp device.

9. The connectable lamp device assembly according to claim 8, wherein a connecting portion between the wire portion and the third connection portion forms a right angle.

10. The connectable lamp device assembly according to claim 6, further comprising a plurality of positioning members on the lamp tubes of the connectable lamp devices, wherein each of the positioning members comprises a clamp and a magnet body, the clamps clamp the upper housings of the connectable lamp devices, and the magnet bodies are on the clamps.
